(19) United States
(12) Patent Application Publication
(10) Pub. No.: US 2011/0057502 A1
(43) Pub. Date: Mar. 10, 2011

(54) WHEEL ROCKING MECHANISM

(76) Inventor: Marie Green, Woodland Hills, CA (US)

(21) Appl. No.: 12/878,860

(22) Filed: Sep. 9, 2010

Related U.S. Application Data
(60) Provisional application No. 61/241,361, filed on Sep. 10, 2009.

(51) Int. Cl. B60B 19/00

(52) U.S. Cl. 301/5.1

(57) ABSTRACT

A wheel rocking system includes a hub for coupling to a rotational axis. A rim is coupled to the hub and a wheel is coupled to the rim. A rocking mechanism is associated with the wheel. The rocking mechanism is operable to provide a rocking motion when the wheel is rotated.

### CROSS REFERENCE

This application claims the benefit of the filing date under 35 USC 119(e) of the filing date of U.S. Provisional Application Ser. No. 61/241,361, filed Sep. 10, 2009, the contents of which are incorporated herein by reference.

### BACKGROUND OF INVENTION

This application relates to the field of wheels and more particularly to mechanisms and arrangements for imparting a rocking motion to one or more wheels.

### SUMMARY

A rocking motion is often soothing and comforting for babies and young children. While rocking babies and young children is effectual in calming them down, it often makes it difficult to do other tasks as it frequently involves sitting with or holding the child. This is particularly time consuming and inconvenient when the child has been taken out in a stroller. Therefore, it would be beneficial to be able to rock a child while the child is being transported in a device such as a stroller.

In particular, this application discloses a wheel rocking system comprising: a hub for coupling to a rotational axis; a rim coupled to the hub; a wheel coupled to the rim; and a rocking mechanism associated with the wheel, the rocking mechanism operable to provide a rocking motion when the wheel is rotated.

This application also discloses a wheel rocking system comprising: a hub for coupling to a rotational axis; a rim coupled to the hub; a wheel coupled to the rim, the wheel having a curvature; and an adjustable rocking mechanism associated with the wheel, the rocking mechanism selectively movable between a rocking position, whereby the rocking mechanism is operable to provide a rocking motion when the wheel is rotated, and a neutral position, whereby no rocking motion is provided to the wheel by the rocking mechanism when the wheel is rotated.

This application further discloses a rocking mechanism for imparting a rocking motion to a wheel assembly, the rocking mechanism comprising: a first sidewall; a second sidewall in spaced relationship with the first sidewall, wherein the first and second sidewalls are configured to receive the wheel therebetween; a first surface extending between the first and second sidewalls, the first surface configured to engage a surface as the wheel is rotated atop the surface such that a rocking motion is imparted to the wheel when the rocking mechanism first surface engages the surface.

### BRIEF DESCRIPTION OF THE DRAWINGS

The drawings, when considered in connection with the following description, are presented for the purpose of facilitating an understanding of the subject matter sought to be protected.

FIG. 1 is a side view of a wheel rocker system;

FIG. 2 is a front view of the wheel rocker system of FIG. 1;

FIG. 3 is a side view of an alternative embodiment of a wheel rocker system;

FIG. 4 is a front view of the wheel rocker system of FIG. 3;

FIG. 5 is a side view of an alternative embodiment of a wheel rocker system;

FIG. 6 is a front view of the wheel rocker system of FIG. 5;

FIG. 7 is a side view of an alternative embodiment of a wheel rocker system;

FIG. 8 is a front view of the wheel rocker system of FIG. 7;

FIG. 9 is a partial cross-sectional view of an alternative embodiment of a wheel rocker system.

### DETAILED DESCRIPTION

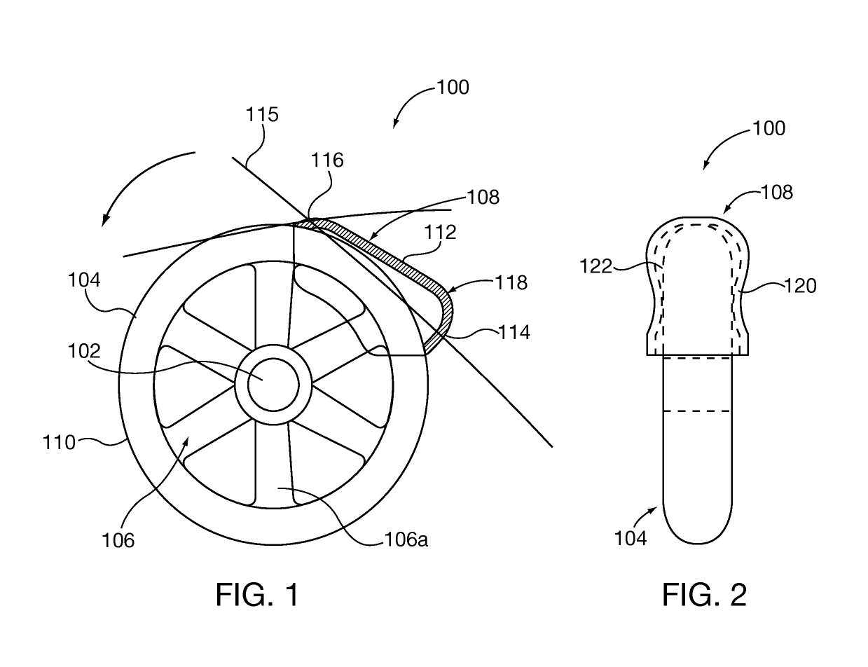

Referring now to FIGS. 1 and 2, a first embodiment of a wheel rocker system 100 is shown. The wheel rocker system 100 generally includes a hub 102, a wheel 104, a rim 106 and a rocking mechanism 108. The wheel 104 includes a circumferential periphery 110 for partially engaging a surface as the wheel 104 rotates such that the wheel 104 rolls over said surface 110. The hub 102 is coupled to a rotational axis (not shown) whereby rotation of the axis is imparted to the wheel 104 via the hub 102 and rim 106. Alternatively, rotation of the wheel 104 may be imparted to the axis via the rim 106 and hub 102. In yet another alternative, the hub 102 may be rotationally coupled to a frame or other suitable body such that the wheel 104 is operable to rotate relative to the frame or other suitable body. The rim 106 extends between the hub 102 and the wheel 104. In one embodiment, the rim 106 rigidly secures the wheel 104 to the hub 102. While the rim 106 is shown as comprising a plurality of spokes 106a, it will be appreciated that the rim 106 may have any suitable configuration operable to couple the wheel 104 to the hub 102.

The rocking mechanism 108 is capable of engaging the wheel 104. In the illustrative embodiment, the mechanism 108 includes first and second sidewalls 120 for releasably engaging the sidewalls 122 of the wheel 104. As will be discussed further below, the rocking mechanism 108 is operable to impart a rocking motion to the wheel 104 as the wheel 104 rotates or rolls over a surface. The rocking mechanism 108 may include a first surface 112 and a second surface 114, each operable to engage a surface, such as a sidewalk, ground, etc., as the wheel 104 rotates thereon. The first surface 112 may be substantially tangential to the wheel periphery 110. Alternatively, as shown in FIG. 1, the first surface 112 may be substantially parallel with and slightly offset from a line 115 tangential to the wheel periphery 110. In this instance, a first end 116 of the first surface 112 may be curved toward the wheel periphery 110 such that a relatively smooth transition may be made from the wheel periphery 110 to the first surface 112 during wheel 104 rotation over a surface. However, it will be appreciated that the first surface 112 may be in any suitable relationship relative to the wheel periphery 110 and remain within the scope of the present disclosure. The first surface 112 and second surface 114 intersect at an apex 118. In the illustrative embodiment, the apex 118 is rounded such that a relatively smooth transition may be made from the first surface 112 to the second surface 114 as the mechanism 108 rotates over a surface. In the illustrative embodiment, the second surface 114 is not tangential to the wheel periphery 110; however, it will be appreciated that the second surface 114 may be in any suitable relationship relative to the wheel periphery, including, but not limited to, tangential.

In operation, the wheel 104 rotates or rolls over any suitable surface. During such rotation, the rocking mechanism 108 may be rotated towards the surface such that the rocking mechanism first surface 112 engages the surface such that the rocking mechanism 108 lifts the wheel to initiate a rocking motion. With continued rotation, the rocking mechanism 108 may continue to lift the wheel 104 until the apex 118 engages the surface, after which the second surface 114 engages the surface and the wheel 104 is lowered until the wheel periphery 110 again engages the surface thereby terminating the rocking motion. The wheel 104 and/or axle impart the rocking motion to the device the wheel 104 is rotatably coupled to. The rocking mechanism 108 may be employed with any suitable wheel coupled to any suitable device, including, but not limited to, infant stroller, bicycles, tricycles, scooters, etc.

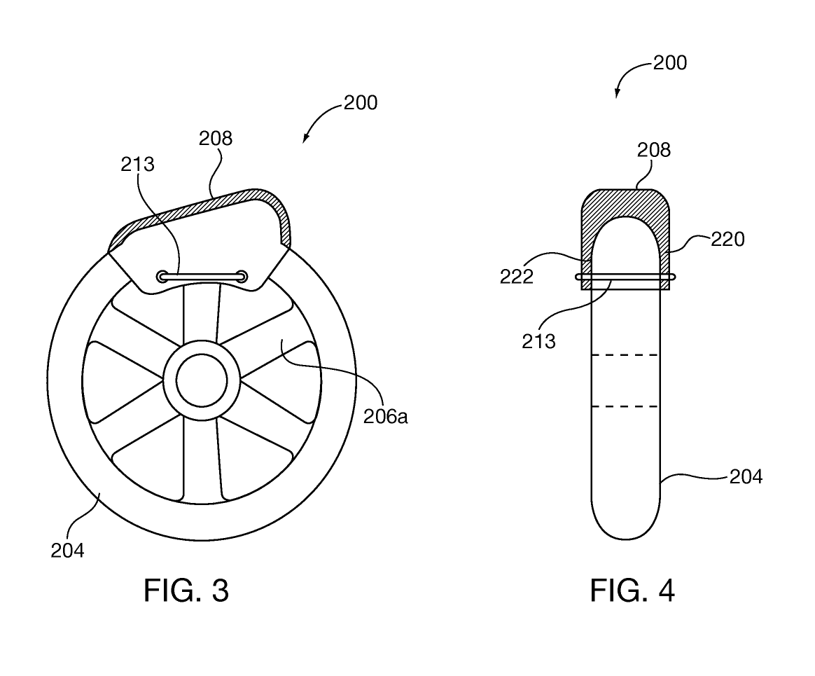

Referring to now to FIGS. 3 and 4, another illustrative embodiment of a wheel rocker system 200 is shown. The wheel rocker system 200 is analogous in most respects to the wheel rocker system 100 of FIGS. 1 and 2 and a correlation of parts is generally indicated in this embodiment by indexing the numerals in FIGS. 1 and 2 by 100. In the present embodiment, the rocker mechanism 208 is releasably coupled to the wheel 204 via a coupling mechanism 213. The coupling mechanism 213 may be any suitable device for releasably coupling the rocking mechanism 208 to the wheel 204, including, but not limited to, one or more elastic ties, one or more wires, one or more ropes or strings, etc. The coupling mechanism 213 may be operable to draw the rocking mechanism sidewalls 220 into engagement with the wheel sidewalls 222; however, it will be appreciated that the mechanism sidewalls 220 may engage the wheel sidewalls 222 without the use of the coupling mechanism 213. In one embodiment, the coupling mechanism 213 may be configured to be tied on or about one or more spokes 206a

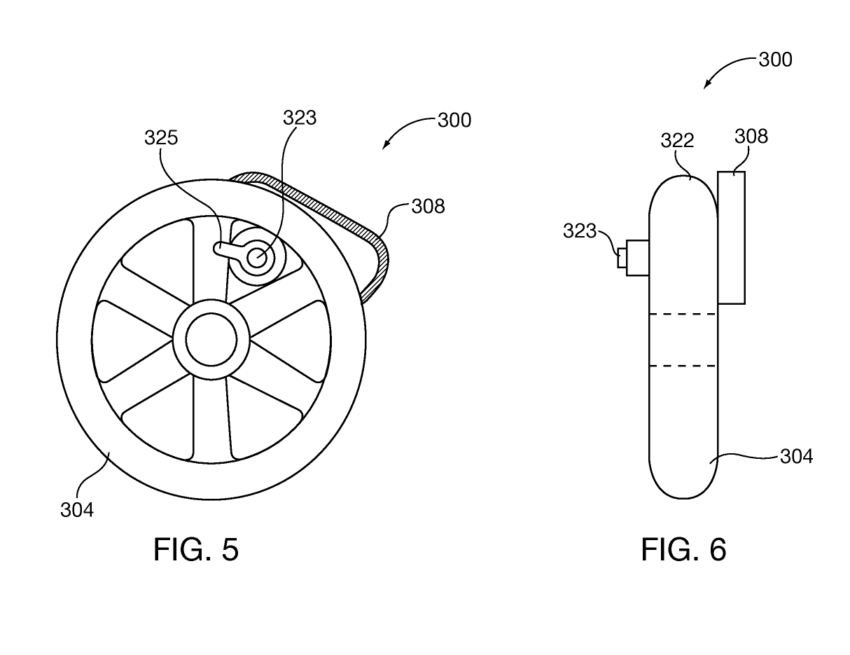

Referring now to FIGS. 5 and 6, another illustrative embodiment of a wheel rocker system 300 is shown. The wheel rocker system 300 is analogous in most respects to the wheel rocker system 100 of FIGS. 1 and 2 and a correlation of parts is generally indicated in this embodiment by indexing the numerals in FIGS. 1 and 2 by 200.In this embodiment, the rocking mechanism 308 is releasably coupled adjacent to one wheel side wall 322. The rocking mechanism 308 may be releasably coupled to the wheel 308 via any suitable means. In the illustrative embodiment, a bolt 323 extends through the rim 306. A rotatable arm 325 is disposed at the distal end of the bolt 323 and is operable to be moved from a first position to a second position where the arm 325 releasably engages the rim 106 or spoke 106a to releasably secure the rocking mechanism to the rim 106. The rocking mechanism 308 may be removed from the rim 106 by rotating the arm 325 to the first position and pulling the rocking mechanism 308 laterally away from the wheel 304 such that the bolt 323 and arm 325 are pulled through the rim 106.

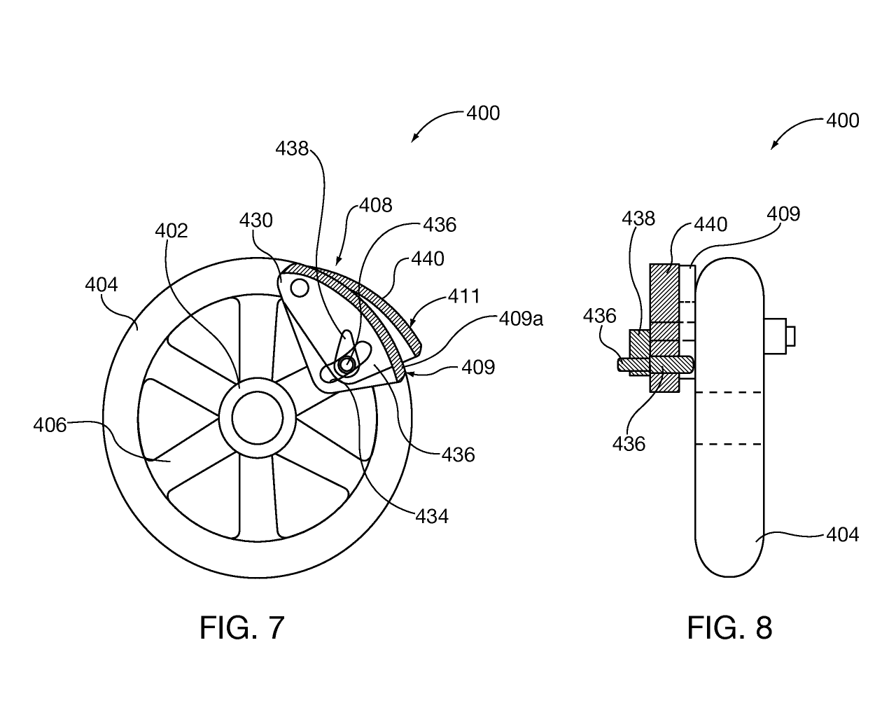

Referring now to FIGS. 7 and 8, another illustrative embodiment of a wheel rocker system 400 is shown. The hub 402, a wheel 404, and rim 406 are the same or substantially similar to those of FIGS. 1 and 2. The rocking mechanism 408 includes a static portion 409 and a movable portion 411. The static portion 409 is rigidly secured to the wheel 404 via any suitable means, including, but not limited to, mechanical fasteners, welding, bonding, adhesive(s), or the like. The static portion 409 includes a surface 409a that is curved to substantially match the curvature of the wheel 404. The movable portion also includes a curved surface 440 that substantially matches the curvature of the wheel 404.

Near the first end 430 of movable portion 411, the movable portion 411 is is rotatably fixed to the static portion 409. A second end 432 of the movable portion 411 is releasably secured to the static portion 409. In the illustrative embodiment, the movable portion 411 includes an arcuate slot 434 for receiving a peg 436 extending from the static portion 409. A nut 438 may be releasably coupled to the peg 436 and operable to selectively and releasably couple the second end 432 of the movable portion 411 to the static portion 409. In one embodiment, the arcuate slot 434 and peg 436 limit rotation of the movable portion 411 relative to the static portion 409 while also allowing a user to vary the height and/or amount of rocking motion provided by the rocking mechanism 408. Thus, the movable portion 411 may be pivoted such that curved surface 440 is substantially aligned with the curved surface 409a of the static portion 409 such that no rocking motion is produced, and also pivoted such that the surfaces 440, 409a are not aligned such that the curved surface 440 of the movable portion 411 engages the surface rolled over whereby the rocking mechanism 408 imparts a rocking motion to the wheel 404. In an alternative embodiment, the movable portion 411 may be secured between the static portion 409 and wheel 404.

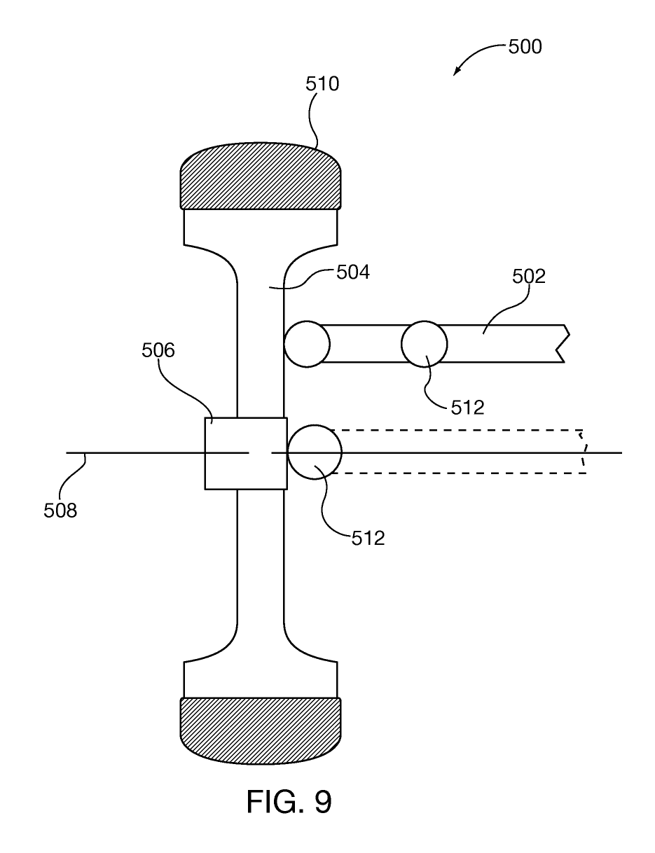

Referring now to FIG. 9, an alternative embodiment of a wheel rocker system 500 is disclosed. In this arrangement, an axle 502 is hingeldy coupled to the rim 504 or hub 506 in a manner offset from the center 508 of the wheel 510. The axle 502 may include a second hinge 512 laterally offset from the wheel 510. The axle 502 is thus movable from a first, or rocking position, wherein the axle 502 is offset from the wheel center 508 and a second position wherein the axle 502 is substantially aligned with the wheel center 508. Thus, a user may selectively move the axle 502 between a rocking and non-rocking position.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A wheel rocking system comprising:
a hub for coupling to a rotational axis;
a rim coupled to the hub;
a wheel coupled to the rim; and
a rocking mechanism associated with the wheel, the rocking mechanism operable to provide a rocking motion when the wheel is rotated.

2. The wheel rocking system of claim 1 wherein the rocking mechanism includes a first surface and a second surface each adapted to engage a surface as the wheel is rotated.

3. The wheel rocking system of claim 2 wherein the first surface is substantially perpendicular to the second surface.

4. The wheel rocking system of claim 2 wherein the first surface is substantially parallel with a line tangential to the wheel.

5. The wheel rocking system of claim 1 wherein the rocking mechanism further comprises first and second sidewalls.

6. The wheel rocking system of claim 5 wherein the first and second sidewalls are configured to frictionally engage the wheel therebetween.

7. The wheel rocking system of claim 1 further comprising a coupling mechanism for releasably securing the rocking mechanism to at least one of the wheel and rim.

8. The wheel rocking system of claim 7 wherein the coupling mechanism is at least one of an elastic tie, wire, rope, and string.

9. The wheel rocking system of claim 7 wherein the coupling mechanism includes a bolt configured to releasably engage the rim such that the rocking mechanism is releasably engagable to the rim.

10. A wheel rocking system comprising:
a hub for coupling to a rotational axis;
a rim coupled to the hub;
a wheel coupled to the rim, the wheel having a curvature; and
an adjustable rocking mechanism associated with the wheel, the rocking mechanism selectively movable between a rocking position, whereby the rocking mechanism is operable to provide a rocking motion when the wheel is rotated, and a neutral position, whereby no rocking motion is provided to the wheel by the rocking mechanism when the wheel is rotated.

11. The wheel rocking system of claim 10 wherein the rocking mechanism comprises a movable portion that is selectively movable between the rocking position and the neutral position.

12. The wheel rocking system of claim 11 wherein the movable portion comprises an arcuate surface adapted to engage a surface the wheel is rotated atop.

13. The wheel rocking system of claim 12 wherein the movable portion arcuate surface is substantially aligned with the wheel curvature when the rocking mechanism is in the neutral position.

14. The wheel rocking system of claim 11 further comprising a static portion wherein the static portion is rigidly coupled to the wheel and wherein the movable portion is hingedly coupled to the static portion.

15. The wheel rocking system of claim 10 further comprising a locking mechanism for selectively securing the rocking mechanism in each of the rocking position and neutral position.

16. A rocking mechanism for imparting a rocking motion to a wheel assembly, the rocking mechanism comprising:
a first sidewall;
a second sidewall in spaced relationship with the first sidewall, wherein the first and second sidewalls are configured to receive the wheel therebetween;
a first surface extending between the first and second sidewalls, the first surface configured to engage a surface as the wheel is rotated atop the surface such that a rocking motion is imparted to the wheel when the rocking mechanism first surface engages the surface.

17. The rocking mechanism of claim 16 further comprising a second surface extending between the first and second sidewalls, the second surface adapted to engage the surface as the wheel is rotated about the surface.

18. The rocking mechanism of claim 17 wherein the first surface is substantially perpendicular to the second surface.

19. The rocking mechanism of claim 16 wherein the first surface is substantially parallel with a line substantially tangential to the wheel.

20. The rocking mechanism of claim 16 wherein the first and second sidewall are adapted to frictionally engage the wheel.
